(19) United States
(12) Patent Application Publication
(10) Pub. No.: US 2005/0154146 A1
(43) Pub. Date: Jul. 14, 2005

(54) Process for the preparation of iron ion containing water-absorbent polymers with low residual monomer content

(76) Inventor: Josef H Burgert, Achern (DE)

Correspondence Address: THE DOW CHEMICAL COMPANY;INTELLECTUAL PROPERTY SECTION, P. O. BOX 1967, MIDLAND, MI, 48641-1967, US

(21) Appl. No.: 10/517,572

(22) PCT Filed: May 19, 2003
(86) PCT No.: PCT/US03/15940

(30) Foreign Application Priority Data
Jun. 26, 2002 (US) 60392706

(51) Int. Cl. C08F 8/42

(52) U.S. Cl. 525/337; 528/481

(57) ABSTRACT

The residual monomer content of water-absorbent carboxyl-containing polymers is reduced using iron ions.

This invention relates to a process for the preparation of water-absorbent carboxyl-containing polymers that have a low residual monomer content.

Water-absorbent polymers, also referred to as superabsorbent polymers or aqueous fluid absorbent polymers, are primarily used in personal care products which absorb body fluids, for example, baby diapers, adult incontinence products and feminine hygiene products. In such applications, superabsorbent polymer particles are incorporated into absorbent structures that contain synthetic and/or natural fiber or paper based, woven and nonwoven structures, or toughened masses of fibers, such as fluff pads. The materials used in such structures can quickly absorb aqueous fluids and distribute them throughout the whole absorbent structure. The structures, in the absence of superabsorbent polymers, have limited absorption capacity, are bulky due to the large amount of material needed to provide acceptable absorption capacity, and do not retain fluid under pressure. A means for improving the absorbency and fluid retention characteristics of such absorbent structures is to incorporate superabsorbent polymer particles that imbibe fluids to form a swollen hydrogel material.

Various methods of lowering the level of residual monomer in water-absorbent polymer particles are known in the art. For example, EP 505 163 relates to a method for reducing residual (meth)acrylic acid present in poly(acrylic acid) water-absorbent gel polymers which comprises treating these polymers with a combination of a surfactant having a certain HLB and a vinylic addition compound that can react with a vinylic double bond. Examples of the vinylic addition compound include sulfites and bisulfites. The surfactant and the vinylic addition compound maybe used in admixture with oxidizing anions, such as peroxodisulfate and peroxide. An aqueous solution of the additives is mixed with the water-absorbent polymer in the form of dry polymer or swollen gels or beads. Unfortunately, the presence of surfactants is believed to negatively affect liquid distribution when the polymer is wetted. In addition, vinyl addition compounds like sulfites and bisulfites can generate offensive odors during processing.

U.S. Pat. No. 4,659,793 teaches that very small amounts of certain metal ions (Zn²⁺, Co³⁺, Co²⁺, Cu²⁺, Mo²⁺, Fe³⁺, Fe²⁺, Cr³+, Ni²+, Ce³⁺ and Ce²⁺) promote the copolymerization of ethylenically unsaturated dicarboxylic acid monomers, especially maleic acid, and α,β-ethylenically unsaturated monomers having carboxyl or sulfonic acid groups, such as (meth)acrylic acid or 2-acrylamido-2-methyl propane sulfonic acid, whereby the amount of unreacted dicarboxylic acid monomer is significantly reduced. The metal ions are added to the monomer mixture. The resulting copolymer is not described as a superabsorbent polymer but is useful in antiscalants, dispersants, detergent additives, deflocculants etc.

The use of various metal salts in a polymerization method is also known from U.S. Pat. No. 5,439,993, which discloses a process for producing a water absorptive polymer by polymerizing an acrylic monomer in the presence of a salt of metal selected from the group consisting of Fe(II), Fe(III), Cu(I), Cu(II), Mn(II), VO(II), Co(II) and Ni(II). The metal salts are added to the monomer mixture, and reverse phase suspension polymerization is the preferred polymerization method. However, aqueous solution polymerization methods may also be used. It is not taught in this reference that the metal ions are added to reduce the amount of residual monomer in the final polymer product.

German Patent Publication 4127814 is directed to a process for the production of a water adsorptive polymer having a reduced amount of residual monomers comprising the addition of a reducing material and a radical scavenger in any step of drying or comminuting the polymer obtained after polymerization. Fe(II) salts are mentioned among others as suitable reducing agents.

U.S. Pat. No. 5,629,377 discloses a process for preparing water-absorbent polymer particles comprising polymerizing unsaturated carboxyl-containing monomers in the presence of a chlorine- or bromine-containing oxidizing agent to form a hydrogel which is then heated at a temperature of from 170° C. to 250° C., preferably of from 210° C. to 235° C. Alternatively, the chlorine- or bromine-containing oxidizing agent may be added to the polymerized hydrogel. The method is effective for improving absorbency, for example, centrifuge capacity and absorbency under load (AUL), while keeping the amount of residual monomers at an acceptable level. However, the high heat treat temperature needed to activate the chlorine- or bromine-containing oxidizing agent is detrimental for various reasons, including high energy usage and loss of moisture.

Numerous other methods are known to reduce the amount of residual monomers in superabsorbent materials, for example, the use of sulfites, bisulfites, ammonia, amines, amino acids like cystein and lysine, sulfurous acid, phosphorous acid, pyrophosphorous acid, hypophosphorous acid, thiosulfuric acid, hydroxylamine or a salt thereof, and ascorbic acid (see U.S. Pat. Nos. 5,229,488, 5,866,678, 4,766,173, and 4,929,717).

It would be highly desirable to provide a novel, improved method for the preparation of a water-absorbent polymer having a low residual monomer level.

This invention relates to a process for the preparation of a water-absorbent polymer which comprises

(I) polymerizing a polymerization ,mixture comprising:
(a) one or more ethylenically unsaturated carboxyl-containing monomers,
(b) one or more crosslinking agents,
(c) optionally one or more comonomers copolymerizable with the carboxyl-containing monomer,
(d) a polymerization medium, and
(e) a chlorine- or bromine-containing oxidation agent to form a crosslinked hydrogel,

(II) comminuting the hydrogel to particles and

(III) drying the hydrogel at a temperature of greater than 105° C.;

wherein Fe(II) ions or Fe(III) ions or a mixture of both are added to the hydrogel prior to, during or after the comminution step (II) but prior to substantial drying of the hydrogel in step (III).

This invention also concerns a process for the preparation of a water-absorbent polymer which comprises:

(I) polymerizing a polymerization mixture comprising:
(a) one or more ethylenically unsaturated carboxyl-containing monomers,
(b) one or more crosslinking agents,
(c) optionally one or more comonomers copolymerizable with the carboxyl-containing monomer,
(d) a polymerization medium, and
(e) a chlorine- or bromine-containing oxidation agent to form a crosslinked hydrogel,

(II) comminuting the hydrogel to particles and

(III) drying the hydrogel at a temperature of greater than 105° C.;

wherein Fe(II) ions or Fe(III) ions or a mixture of both are added in an amount of from 1 to 20 ppm, based on the total weight of monomers, to the polymerization mixture prior to step (I).

This invention is further directed to a process for the preparation of a water-absorbent polymer which comprises:

(I) polymerizing a polymerization mixture comprising:
(a) one or more ethylenically unsaturated carboxyl-containing monomers,
(b) one or more crosslinking agents,
(c) optionally one or more comonomers copolymerizable with the carboxyl-containing monomer,
(d) a polymerization medium, and
(e) a chlorine- or bromine-containing oxidation agent to form a crosslinked hydrogel,

(II) comminuting the hydrogel to particles and

(III) drying the hydrogel at a temperature of greater than 105° C.;

wherein Fe(III) ions are added to the polymerization mixture prior to step (I).

In another aspect this invention relates to a process for the preparation of a water-absorbent polymer which comprises:

(I) polymerizing a polymerization mixture comprising:
(a) one or more ethylenically unsaturated carboxyl-containing monomers,
(b) one or more crosslinking agents,
(c) optionally one or more comonomers copolymerizable with the carboxyl-containing monomer, and
(d) a polymerization medium
to form a crosslinked hydrogel,

(II) comminuting the hydrogel to particles,

(III) applying to the hydrogel a chlorine- or bromine-containing oxidation agent prior to, during or after the comminution step (II), and

(IV) drying the hydrogel at a temperature of greater than 105° C.;

wherein Fe(II) ions or Fe(III) ions or a mixture of both are added in at least one of the following steps:

(i) prior to the comminution step (II) or

(ii) after the comminution step (II) but prior to substantial drying of the hydrogel in step (IV).

In a further aspect this invention is directed to a process for the preparation of a water-absorbent polymer which comprises:

(I) polymerizing a polymerization mixture comprising:
(a) one or more ethylenically unsaturated carboxyl-containing monomers,
(b) one or more crosslinking agents,
(c) optionally one or more comonomers copolymerizable with the carboxyl-containing monomer, and
(d) a polymerization medium
to form a crosslinked hydrogel,

(II) comminuting the hydrogel to particles,

(III) applying to the hydrogel a chlorine- or bromine-containing oxidation agent prior to, during or after the comminution step (II), and

(IV) drying the hydrogel at a temperature of greater than 105° C.;

wherein Fe(II) ions or Fe(III) ions or a mixture of both are added in an amount of from 1 to 10 ppm, based on the total weight of monomers, to the polymerization mixture prior to step (I).

In yet another aspect this invention is concerned with a process for the preparation of a water-absorbent polymer which comprises:

(I) polymerizing a polymerization mixture comprising:
(a) one or more ethylenically unsaturated carboxyl-containing monomers,
(b) one or more crosslinking agents,
(c) optionally one or more comonomers copolymerizable with the carboxyl-containing monomer, and
(d) a polymerization medium
to form a crosslinked hydrogel,

(II) comminuting the hydrogel to particles,

(III) applying to the hydrogel a chlorine- or bromine-containing oxidation agent prior to, during or after the comminution step (II), and

(IV) drying the hydrogel at a temperature of greater than 105° C.;

wherein Fe(III) ions are added to the polymerization mixture prior to step (I).

This invention relates to a process for the preparation of a water-absorbent polymer, the process comprising:

(I) polymerizing a polymerization mixture comprising:
(a) one or more ethylenically unsaturated carboxyl-containing monomers,
(b) one or more crosslinking agents,
(c) optionally one or more comonomers copolymerizable with the carboxyl-containing monomer,
(f) a polymerization medium, and
to form a crosslinked hydrogel,

(II) comminuting the hydrogel to particles and

(III) drying the hydrogel at a temperature of greater than 105° C.;

wherein, under conditions sufficient to reduce the residual monomer level in the polymer product, the following are independently added to the process prior to substantial drying of the hydrogel in step (III): (a) Fe(III) ions; and (b) at least one chlorine- or bromine-containing oxidation agent.

The key element of the present invention is -the addition of ferrous and/or ferric ions in the process for the preparation of the water-absorbent polymer using the chlorine- or bromine-containing oxidation agent. The addition of ferrous and/or ferric ions was surprisingly found to result in reduced residual monomer content, regardless of how the iron ions were incorporated into the process. The present invention does not comprise technically complicated and time-consuming process steps and productivity is not reduced compared to processes not employing iron ions.

The water-absorbent polymer of the present invention after drying, but before any optional heat treatment, has a low residual monomer content, preferably less than 500 ppm and more preferably less than 200 ppm, all based on weight of dry polymer. The heat-treated water-absorbent polymer of the present invention also has low residual monomer content, preferably less than 300 ppm and more preferably less than 200 ppm, based on the weight of dry polymer.

An important aspect of the present invention is the addition ferrous and/or ferric ions to the process for preparing the water-absorbent polymer. These ions are employed in an amount sufficient to reduce the residual monomer level in the relevant polymer compared to a polymer made under-identical conditions using the same materials without the iron ions. The amount of Fe(II) ions or Fe(III) ions or the total amount of both ions, if a mixture of Fe(II) and Fe(III) is used, preferably ranges from 1 to 20 ppm, and more preferably from 1 to 10 ppm, even more preferably from 2 to 10 ppm and most preferably from 3 to 7 ppm, all based on the total weight of monomers (a), (b), and (c). Premature polymerization may result if more than 20 ppm of iron-ions are used. Premature initiation can lead to nonhomogeneous polymerization conditions, which tend to increase the level of residual monomer rather than decrease it. Furthermore, product color may start to deteriorate with increasing iron concentration.

The iron ions may be added as one or more dry iron salts or as a solution of one or more iron salts or any combination of these. The solution may be either an aqueous solution, a non-aqueous organic solution or a solution in a mixture of water and organic solvent, with an aqueous solution being preferred. An aqueous solution may also be prepared by complexation of water-insoluble iron salts.

Water-soluble iron salts, also termed soluble iron salts hereafter, are a preferred source of iron ions. The solubility of the iron salts advantageously is such that the desired amount of iron ions is provided. Soluble iron salts preferably have a solubility in pH neutral water at room temperature of at least 0.001 g Fe ions per liter. More preferably, water-soluble iron salts have a solubility in water at room temperature of at least 0.01 Fe ions g per liter; most preferably, water-soluble iron salts have a solubility of at least 0.1 g per liter.

Any source of Fe(II) or (III) can be employed so long as it results in reduced residual monomer levels. Examples of Fe(II) salts include iron (II) acetate, iron (II) bromide, iron (II) carbonate hydrates, iron (II) chloride hydrates, iron (II) citrate, iron (II) lactate, iron (II) nitrate, iron (II) oxalate, iron (II) oxide hydrates, iron (II) sulfate hydrates, iron (II) phosphate, ammonium iron (II) sulfate hexahydrate, iron (II) perchlorate hydrate, and iron (II) gluconate hydrate. The preferred Fe(II) salts are exemplified by iron (II) acetate, iron (II) bromide, iron (II) chloride hydrates, iron (II) citrate, iron (II) lactate; iron (II) nitrate, and iron (II) sulfate hydrates. The most preferred Fe(II) salts are iron (II) acetate, iron (II) chloride hydrates, and iron (II). sulfate hydrates. Examples of Fe(III) salts include iron (III) acetylacetonate, iron (III) bromide hydrates, iron (III) chloride hydrates, iron (III) citrate, iron (III) lactate, iron (III) nitrate, iron (III) oxalate, iron (III) phosphates, iron (III) sulfate hydrates, and iron (III) perchlorate hydrate. The preferred Fe(III)) salts are exemplified by iron (III) bromide hydrates, iron (III) chloride hydrates, iron (III) citrate, iron (III) lactate, iron (III) nitrate, iron. (III) oxalate, iron (III) sulfate hydrates. The most preferred Fe(III) salts are iron (III) chloride hydrates, and iron (III) sulfate hydrates. Mixtures of iron salts can be employed.

The polymers advantageously are derived from one or more ethylenically unsaturated carboxylic acids, ethylenically unsaturated carboxylic acid anhydrides or salts thereof.

Additionally, the polymers may include comonomers known in the art for use in water-absorbent polymer or for grafting onto the water-absorbent polymers including comonomers such as an acrylamide, an acrylonitrile, a vinyl pyrrolidone, a vinyl sulphonic acid or a salt thereof, a cellulosic monomer, a modified cellulosic monomer, a polyvinyl alcohol or a starch hydrolyzate. If used, the comonomer comprises up to 25 percent by weight of the monomer mixture. Preferred unsaturated carboxylic acid and carboxylic acid anhydride monomers include the acrylic acids typified by acrylic acid, methacrylic acid, ethacrylic acid, α-chloroacrylic acid, α-cyano acrylic acid, β-methyl acrylic acid (crotonic acid), α-phenyl acrylic acid, β-acryloyloxy propionic acid, sorbic acid, α-chloro sorbic acid, angelic acid, cinnamic acid, p-chloro cinnamic acid, beta-styrenic acrylic acid (1-carboxy-4-phenyl butadiene-1,3), itaconic acid, citraconic acid, mesaconic acid, glutaconic acid, maleic acid, fumaric acid and maleic acid anhydride. More preferably the starting monomer is acrylic acid, methacrylic acid, or a salt thereof, with acrylic acid or a salt thereof being most preferred.

The use herein of the prefix “(meth)” with generic terms, such as, for example, “acrylic acid” or “acrylate,” is meant to broaden the terms to include both acrylate and methacrylate species. Thus, the term “(meth)acrylic acid monomer” includes acrylic acid and methacrylic acid.

Preferably, at least 25 mole percent of the carboxylic acid units of the hydrophilic polymer are neutralized with base, even more preferably at least 50 percent and most preferably at least 65 percent. This neutralization may be performed after completion of the polymerization. In a preferred embodiment the starting monomer mix has carboxylic acid moieties which are neutralized to the desired level prior to polymerization. The final polymer or the starting monomers may be neutralized by contacting them with a salt forming cation. Such salt-forming cations include alkali metal, ammonium, substituted ammonium and amine based cations. Preferably, the polymer is neutralized with an alkali metal hydroxide such as, for example, sodium hydroxide or potassium hydroxide, or an alkali metal carbonate such as, for example, sodium carbonate or potassium carbonate.

Polyvinyl crosslinkers known in the art for use in water-absorbent polymers advantageously are employed. Preferable compounds having at least two polymerizable double bonds include: di- or polyvinyl compounds such as divinyl benzene, divinyl toluene, divinyl xylene, divinyl ether, divinyl ketone and trivinyl benzene; di- or polyesters of unsaturated mono- or polycarboxylic acids with polyols, such as di- or tri-(meth)acrylic acid esters of polyols such as ethylene glycol, diethylene glycol, triethylene glycol, tetra ethylene glycol, propylene glycol, dipropylene glycol, tripropylene glycol, tetrapropylene glycol, trimethylol propane, glycerin, polyoxyethylene glycols and polyoxypropylene glycols; unsaturated polyesters that can be obtained by reacting any of the above-mentioned polyols with an unsaturated acid such as maleic acid; di- or polyesters of unsaturated mono- or polycarboxylic acids with polyols derived from reaction of C₂-C₁₀ polyhydric alcohols with 2 to 8 C₂-C₄ alkylene oxide units per hydroxyl group, such as trimethylol propane hexaethoxyl triacrylate; di- or tri-(meth)acrylic acid esters that can be obtained by reacting polyepoxide with (meth)acrylic acid; bis(meth) acrylamides such as N,N-methylene-bisacrylamide; carbamyl esters that can be obtained by reacting polyisocyanates such as tolylene diisocyanate, hexamethylene diisocyanate, 4,4′-diphenyl methane diisocyanate and NCO-containing prepolymers obtained by reacting such diisocyanates with active hydrogen atom-containing compounds with hydroxyl group-containing monomers, such as di-(meth)acrylic acid carbamyl esters obtainable by reacting the above-mentioned diisocyanates with hydroxyethyl(meth)acrylate; di- or poly(meth)allyl ethers of polyols such as alkylene glycols, glycerol, polyalkylene glycols, polyoxyalkylene polyols and carbohydrates such as polyethylene glycol diallyl ether, allylated starch, and allylated cellulose; di- or poly-allyl esters of polycarboxylic acids, such as diallyl phthalate and diallyl adipate; and esters of unsaturated mono- or polycarboxylic acids with mono(meth)allyl ester of polyols, such as allyl methacrylate or (meth)acrylic acid ester of polyethylene glycol monoallyl ether.

Among the preferred classes of crosslinkers are bis(meth)acrylamides; allyl(meth)acrylates; di- or poly-esters of(meth)acrylic acid with polyols such as diethylene glycol diacrylate, trimethylol propane triacrylate, and polyethylene glycol diacrylate; and di- or polyesters of unsaturated mono- or poly-carboxylic acids with polyols derived from reaction of C₁-C₁₀ polyhydric alcohols with 2 to 8 C₂-C₄ alkylene oxide units per hydroxyl group, such as ethoxylated trimethylol propane triacrylate. More preferably the crosslinking agents correspond to Formula 1:
R¹(—(R²O)ₙ—C(O)R³)ₓ Formula 1
wherein:

R¹ is a straight- or branched-chain polyalkoxy radical with 1 to 10 carbon atoms, optionally substituted with one or more oxygen atoms in the backbone, having x valences;

R² is independently in each occurrence an alkylene group of 2 to 4 carbon atoms;

R³ is independently in each occurrence a straight- or branched-chain alkenyl moiety with 2 to 10 carbon atoms; and

n is a number from 1 to 20;

x is a number from 2 to 8.

In the most preferred embodiment the polyvinyl crosslinker corresponds to Formula 1 wherein R¹ is derived from trimethylolpropane, R² is ethylene —(CH₂CH₂)—, R³ is vinyl —(CH═CH₂), the average value of n is from 2 to 8, and the average value of x is from 2 to 3. In particular the most preferred polyvinyl crosslinker is highly ethoxylated trinethylolpropane triacrylate, containing an average of 15 to 16 ethoxyl groups per molecule of trimethylolpropane. Crosslinkers corresponding to Formula 1 are available from Craynor under the trademark Craynor and from Sartomer under the trademark Sartomer. Generally, the crosslinkers described by Formula 1 are found as a mixture of materials described by the formula and by-products of the preparation process.

Non-vinyl crosslinkers that can be employed are compounds having at least two functional groups capable of reacting with the carboxyl groups of the polymer, such as glycerin, polyglycols, ethylene glycol, digylcidyl ether, and diamines. Many examples of these compounds are given in U.S. Pat. Nos. 4,666,983 and 4,734,478, which teach the application of such agents to the surface of absorbent polymer powder followed by heating to crosslink surface polymer chains and improve absorption capacity and absorption rate. Additional examples are given in U.S. Pat. No. 5,145,906, which teaches post-crosslinking with such agents. In the current invention, the non-vinyl crosslinkers, if employed, advantageously are added homogeneously to the polymerization mixture at the start of the process. Preferred non-vinyl crosslinkers include hexane diamine, glycerin, ethylene glycol diglycidyl ether, ethylene glycol diacetate, polyethylene glycol 400, polyethylene glycol 600, and polyethylene glycol 1000. Examples of more preferred non-vinyl crosslinkers include polyethylene glycol 400 and polyethylene glycol 600.

Dimodal crosslinkers are crosslinkers that have at least one polymerizable vinyl group and at least one functional group capable of reacting with a carboxyl group. The term “dimodal crosslinkers” is employed to distinguish these from normal vinyl crosslinkers because they use two different modes of reaction to form a crosslink. Examples of dimodal crosslinkers include hydroxyethyl methacrylate, polyethylene glycol monomethacrylate, glycidyl methacrylate, and allyl glycidyl ether. Many examples of these crosslinkers are given in U.S. Pat. Nos. 4,962,172 and 5,147,956, which teach the manufacture of absorbent films and fibers by (1) the preparation of linear copolymers of acrylic acid and hydroxyl containing monomers, (2) forming solutions of these copolymers into the desired shapes, and (3) fixing the shape by heating the polymer to form ester crosslinks between the pendant hydroxyl and carboxyl groups. In the current invention the dimodal crosslinkers, if employed, advantageously are added homogeneously to the polymerization mixture at the start of the process. Preferred dimodal crosslinkers include hydroxyethyl (meth)acrylate, polyethylene glycol 400 monomethacrylate, glycidyl methacrylate. Hydroxyethyl (meth)acrylate is an example of a more preferred dimodal crosslinker.

The total amount of-all crosslinkers present is sufficient to provide a polymer with good absorptive capacity, good absorption under load, and a low percent of extractable materials. Preferably, the crosslinkers are present in an amount of at least 1,000 parts per million by weight based on the amount of the polymerizable monomer present, more preferably at least 2,000 parts per million and most preferably at least 4000 parts per million. Preferably, the crosslinkers are present in an amount of 50,000 parts per million or less by weight based upon the amount of the polymerizable monomer present, more preferably in amounts of 20,000 parts per million or less and most preferably 15,000 parts per million or less.

In those embodiments of the invention that utilize a blend of polyvinyl crosslinkers with non-vinyl and/or dimodal crosslinkers, the effect on heat-treated capacity of all three types of crosslinkers is generally additive in nature. That is, if the amount of one crosslinker is increased the amount of another must be decreased to maintain the same overall heat-treated capacity. In addition, the proportion of the crosslinker components within the blend may be varied to achieve different polymer properties and processing characteristics. In particular the polyvinyl crosslinkers of the invention are typically, more expensive than non-vinyl or dimodal crosslinkers. Therefore the overall cost of the polymer is reduced if a greater proportion of the crosslinker blend is composed of less expensive non-vinyl and or dimodal crosslinkers. However, the non-vinyl and dimodal crosslinkers of the invention function essentially as latent crosslinkers. That is, the crosslinking imparted to the polymer by these agents is essentially not developed or seen until after the heat-treatment step. Little if any toughness is added to the hydrogel immediately after polymerization by use of such latent crosslinkers. This is an important concern for those processes for which a “tough” gel is desirable.

If too little of the total crosslinker blend is composed of polyvinyl crosslinker the polymerized hydrogel may not have sufficient toughness to be easily ground, processed, and dried. For this reason the proportion of polyvinyl crosslinker in the total crosslinker blend is preferably at least sufficient to produce a hydrogel that has enough toughness to be readily ground, processed, and dried. This toughness is inversely proportional to the centrifuged capacity of the polymer after drying but before heat-treatment. The exact amount of polyvinyl crosslinker required in the blend to achieve this level of toughness will vary, but is enough to provide a centrifuged capacity of the polymer after drying but before heat-treatment of preferably 45 g/g or less, more preferably 40 g/g or less, and most preferably 35 g/g or less.

Conventional additives that are well known in the art, such as surfactants, may be incorporated into the polymerization mixture. Polymerization can be accomplished under polymerization conditions in an aqueous, or non-aqueous polymerization medium or in a mixed aqueous/non-aqueous polymerization medium. Polymerization accomplished by processes which employ non-aqueous polymerization media may use various inert hydrophobic liquids which are not miscible with water, such as hydrocarbons and substituted hydrocarbons including halogenated hydrocarbons as well as liquid hydrocarbons having from 4 to 20 carbon atoms per molecule including aromatic and aliphatic hydrocarbons, as well as mixtures of any of the aforementioned media.

The monomers and crosslinkers are preferably dissolved, dispersed or suspended in a suitable polymerization medium, such as, for example, an aqueous medium, at a concentration of, advantageously, at least 15 weight percent, more preferably at least 25 percent, and most preferably at least 29 percent. The monomers and crosslinkers are preferably dissolved, dispersed or suspended in an aqueous medium.

In one embodiment, the polymer particles are prepared by contacting the monomers and crosslinkers of the invention in an aqueous medium in the presence of a free radical or oxidation reduction (redox) initiator system under conditions such that a crosslinked hydrophilic polymer is prepared. As used herein, the term “aqueous medium” means water, or water in admixture with a water-miscible solvent. Such water-miscible solvents include lower alcohols and non-crosslinking alkylene glycols. Preferably the aqueous medium is water.

Another component of the aqueous medium used to prepare the superabsorbent polymers comprises a free radical initiator, which may be any conventional water soluble polymerization initiator including, for example, peroxygen compounds such as sodium, potassium and ammonium persulfates, caprylyl peroxide, benzoyl peroxide, hydrogen peroxide, cumene hydroperoxide, tertiary butyl diperphthalate, tertiary butyl perbenzoate, sodium peracetate and sodium percarbonate. Conventional redox initiator systems can also be utilized, which are formed by combining the foregoing peroxygen compounds with reducing agents, such as, for example, sodium bisulfite, sodium thiosulphate, L- or iso-ascorbic acid or a salt thereof or ferrous salts. The initiator can comprise up to 5 mole percent based on the total moles of polymerizable monomer present. More preferably the initiator comprises from 0.001 to 0.5 mole percent based on the total moles of polymerizable monomer in the aqueous medium. Mixtures of initiators can be employed.

The process according to the invention is conducted in the presence of a chlorine- or bromine-containing oxidizing agent in addition to the iron ions. Preferred chlorine- or bromine-containing oxidizing agents are bromates and chlorates and chlorites, the chlorates and bromates being even more preferred. The counterion of the bromate, chlorate or chlorite salt can be any counterion which does not significantly interfere in the preparation of the polymer particles or their performance. Preferably, the counterions are alkaline earth metal ions or alkali metal ions. More preferred counterions are the alkali metals, with potassium and sodium being even more preferred. Chlorine-containing oxidizing agents are preferred.

The chlorine- or bromine-containing oxidizing agent is present in a sufficient amount such that the desired balance of polymer properties is achieved. Advantageously, the concentration of the chlorine- or bromine-containing oxidizing agent ranges from 10 to 2000 ppm, based on total weight of the monomer(s) and crosslinker(s), preferably between 50 and 1000 ppm, more preferably between 100 and 800 ppm, and most preferably from 200 to 500 ppm. Preferably, at least 10 ppm by weight of a chlorine- or bromine-containing oxidizing agent based on the total weight of monomer is added, more preferably at least 50 ppm and even more preferably at least 100 ppm and most preferably at least 200 ppm. Desirably, the amount of a chlorine- or bromine-containing oxidizing agent added is 2000 ppm or less by weight based on the total weight of monomer, more desirably 1000 ppm or less, preferably 800 ppm or less and most preferably 500 ppm or less. The chlorine- or bromine-containing oxidizing agent is preferably dissolved or dispersed in the polymerization mixture prior to initiation of the polymerization. However, it may also be applied as an aqueous solution to the hydrogel.

The process of the invention may be performed in a batch manner wherein all of the reaction materials are contacted and the reaction proceeds, or it may take place with the continuous addition of one or more of the components during the reaction period. The polymerization mixture is subjected to polymerization conditions that are sufficient to produce the water-absorbent polymer.

Preferably, the reaction is performed under an inert gas atmosphere, for example, under nitrogen or argon. The reaction may be performed at any temperature at which polymerization occurs, preferably 0° C. or greater, more preferably 25° C. or greater and most preferably 50° C. or greater. The reaction is conducted for a time sufficient to result in the desired conversion of monomer to crosslinked hydrophilic polymer. Preferably, the conversion is 85 percent or greater, more preferably 95 percent or greater and most preferably 98 percent or greater. Advantageously, initiation of the reaction occurs at a temperature of at least 0° C.

The reaction is conducted for a time sufficient to result in the desired conversion of monomer to crosslinked hydrophilic polymer. Preferably, the conversion is at least 85 percent, more preferably at least 95 percent and most preferably at least 98 percent.

It is also possible to prepare the polymer of the current invention with the addition of recycled “fines” to the polymerization mixture. See U.S. Pat. No. 5,342,899. “Fines” are generally considered to include, but are not limited to, the fraction of water-absorbent polymer particles that passes through a 140 mesh screen when dried and ground product is screened prior to heat-treatment. The amount of fines added to the polymerization mixture is preferably less than 12 percent by weight based on the amount of monomer in the polymerization mixture, more preferably less than 10 percent by weight, and most preferably less than 8 percent by weight.

It is also possible to carry out the polymerization process using multiphase polymerization techniques such as inverse emulsion polymerization or inverse suspension polymerization. In the inverse emulsion polymerization or inverse suspension polymerization procedures, the aqueous reaction mixture as hereinbefore described is suspended in the form of tiny droplets in a matrix of a water-immiscible, inert organic solvent such as cyclohexane. Polymerization occurs in the aqueous phase, and suspensions or emulsions of this aqueous phase in an organic solvent permit better control of the exothermic heat of polymerization and further provide the flexibility of adding one or more of the aqueous reaction mixture components in a controlled manner to the organic phase.

Inverse suspension polymerization procedures are described in greater detail in Obayashi et al., U.S. Pat. No. 4,340,706; Flesher et. al. U.S. Pat. No. 4,506,052; and Stanley et al. U.S. Pat. No. 5,744,564. When inverse suspension polymerization or inverse. emulsion polymerization techniques are employed, additional ingredients such as surfactants, emulsifiers and polymerization stabilizers may be added to the overall polymerization mixture. When any process employing an organic solvent is utilized, it is preferred that the hydrogel-forming polymer material recovered from such processes be treated to remove substantially all of the excess organic solvent. Preferably, the hydrogel-forming polymers contain no more than about 0.5.percent by weight of residual organic solvent.

During polymerization, the polymer of the invention generally absorbs the aqueous reaction medium to form a hydrogel. The polymer is removed from the reactor in the form of an aqueous hydrogel. The term “hydrogel” as used herein refers to water swollen water-absorbent polymer or polymer particles. In a preferred embodiment, the hydrogel coming out of the reactor comprises 15 to 50 percent by weight polymer, with the remainder comprising essentially water. In a more preferred embodiment, the hydrogel comprises 25 to 45 percent polymer. The hydrogel is preferably processed into a particulate shape during the polymerization reaction process in the reactor by the agitator in order to facilitate the removal of the hydrogel from the reactor. Preferred particle sizes of the hydrogel range from 0.001 to 25 cm, more preferably from 0.05 to 10 cm. In multiphase polymerization, the water-absorbent polymer hydrogel particles may be recovered from the reaction medium by azeotropic distillation and/or filtration followed by drying. If recovered by filtration then some means of removing the solvent present in the hydrogel must be used. Such means are commonly known in the art.

The polymer of the invention may be in the form of particles or other forms, such as fibers.

After removal from the reactor, the hydrogel polymer is subjected to comminution, such as, for example, by a convenient mechanical means of particle size reduction, such as grinding, chopping, cutting, mincing, extrusion or a combination thereof. The size of the gel particles after particle size reduction should be such that homogeneous drying of the particles can occur. Preferred particle sizes of the hydrogel are from 0.5 to 3 mm. This particle size reduction can be performed by any means known in the art that gives the desired result. Preferably the particle size reduction is performed by extruding the hydrogel through a perforated plate and/or by chopping the hydrogel.

The iron ions may be added to the polymerization mixture during polymerization or, preferably, prior to the beginning of the polymerization, or to the crosslinked hydrogel prior to, during or after comminution but prior to drying of the hydrogel. The presence of iron ions in the water-absorbent polymer particles prior to drying determines the effect on residual monomer, regardless of the method by which the iron ions were introduced to water-absorbent polymer particles. When the iron ions are added to the polymerization mixture prior to the beginning of the polymerization, or to the crosslinked hydrogel prior to, during or after comminution, followed by a drying step, the iron ions are distributed substantially uniformly through the water-absorbent polymer particle rather than concentrated at the particle surfaces. Preferably,.the iron ions are added as an aqueous solution to the polymerization mixture prior to polymerization or to the wet hydrogel that is fed to the dryer prior to drying, resulting in water-absorbent polymer particles with excellently improved, low residual monomer levels. It is within the scope of the present invention to add the iron ions at several stages in the process, for example, both prior to and after the comminution step, as long as the addition is before any substantial degree of water moisture is removed.

The iron ions can be added to the polymerization mixture with agitation. The mixing of the polymerization mixture and the iron ions can be done using simple mixing devices. The iron ions may be added together with the initiator solution. When the iron ions are added to the crosslinked hydrogel, additional mixing measures may be applied to improve the distribution of the iron ions within the hydrogel. Any suitable mixing measure can be employed. Examples of advantageous mixing methods include stirring, kneading and agitating. It is preferred to add the iron ions prior to the comminuting step since intensive mixing inherently occurs during comminuting the hydrogel to particles.

When an aqueous iron salt solution is used, it is preferably sprayed on the crosslinked hydrogel. The concentration of the iron salt solution is not critical, as long as sufficient distribution of the iron salt within the hydrogel is obtained. Desirable concentrations of the iron salt range from 1 to 20 ppm iron, based on polymer weight in the gel, preferably between 2 and 20 ppm and more preferably between 2 and 10 ppm.

If an aqueous solution of a chlorine- or bromine-containing oxidizing agent is added to the hydrogel this may be applied in a similar manner to the method by which the solution comprising iron is added, that is, it may be contacted with the hydrogel prior to, during or after comminution, together with the iron salt or as a separate solution. The preferred concentration of the chlorine- or bromine-containing oxidizing agent in water is from 0.1 to 10 percent by weight; however, this concentration is not critical.

If the solution comprising iron ions is applied to the hydrogel after comminution, further components selected from water-insoluble fine- inorganic or organic particles, surfactants, organic solvents, oils, such as mineral oil, and mixtures thereof may be added to avoid sticking and/or improve flow properties of the gel particles and/or to achieve better distribution of the iron salt. If the iron ions are applied prior to the comminution step, the additives are not necessary and it is even preferred to contact the solution comprising iron ions with the hydrogel in the absence of those additives since the incorporation of additives may have a negative impact on absorbent polymer properties.

After comminuting the hydrogel to particles, the hydrogel is subjected to drying conditions to remove the remaining polymerization medium and any dispersing liquid including the optional solvent and substantially all of the water. Desirably, the moisture content of the polymer after drying is between zero and 20 percent by weight, preferably between 5 and 10 percent by weight.

Drying techniques are well known to those skilled in the art. The temperature at which the drying takes place-advantageously is greater than 105° C. and is high enough that any liquids, including water and optional solvents, are removed in a reasonable time period. The drying temperature should not be so high as to cause degradation of the polymer particles, such as by breaking the crosslink bonds in the polymer. Preferably, the drying temperature is 210° C. or less, more preferably 180° C. or less. Preferably, the temperature during drying is 120° C. or above and more preferably 150° C. or above.

The drying time is not critical as long as it is sufficient to remove substantially all of the water and optional solvent. Preferably, a minimum time for drying is at least 10 minutes, with at least 15 minutes being preferred. Preferably, the drying time is 60 minutes or less, with 25 minutes or less being more preferred. In a preferred embodiment, drying is performed under conditions such that water, and optional solvent, volatilizing away from the absorbent polymer particles is removed. This can be achieved by the use of vacuum techniques or by passing inert gases or air over or through the layers of polymer particles. In a preferred embodiment, the drying occurs in dryers in which heated air is blown through or over layers of the polymer particles. Preferred dryers are fluidized beds or belt dryers. Alternatively, a drum dryer may be used. Alternatively, the water may be removed by azeotropic distillation. Such techniques are well known in the art.

During drying, the water-absorbent polymer particles may form agglomerates and may then be subjected to comminution, such as, for example, by mechanical means for breaking up the agglomerates. In a preferred embodiment, the water-absorbent polymer particles are then subjected to mechanical particle size reduction means. Such means can include chopping, cutting-and/or grinding. The object is to reduce the particle size of the polymer particles to a particle size acceptable for the ultimate end use. In a preferred embodiment, the polymer particles are chopped and then ground. The final particle size is preferably 2 mm or less, more preferably 0.8 mm or less. Preferably the particles have a size of at least 0.01 mm, more preferably at least 0.05 mm. Dried water-absorbent polymer particles of the present invention can be used as the basis polymer for further surface crosslinking treatment using, for example, polyvalent cations such as aluminum ions, and/or using one of the crosslinkers mentioned above by coating and subsequent heating at elevated temperatures using known surface crosslinking methods.

In a preferred embodiment after drying and optional particle size reduction, the polymer particles are subjected to a heat-treatment step. Heat-treatment of the polymer provides a beneficial increase in the absorption under load (AUL) of the water-absorbent polymer, particularly the AUL under higher pressures. Suitable devices for heat-treatment include, but are not limited to, rotating disc dryers, fluid bed dryers, infrared dryers, agitated trough dryers, paddle dryers, vortex dryers, and disc dryers. One of ordinary skill in the art would vary the time and temperature of heat-treatment as appropriate for the heat transfer properties of the particular equipment used. If desired, the heat treated particles can optionally be subjected to a surface crosslinking process. As stated hereinabove, conventional surface crosslinking techniques can be employed. The surface crosslinking step can be performed before and/or after heat treatment.

The time period and temperature of the heat-treatment step are chosen such that the absorption properties of the polymer are improved as desired. The polymers are desirably heat-treated at a temperature of 170° C. or above, more desirably 180° C. or above, preferably at 200° C. or above and most preferably at 220° C. or above. Below 170° C. no improvement in the absorption properties is generally seen. The temperature should not be so high as to cause the polymer to degrade. Preferably, the temperature is 250° C. or below and more preferably 235° C. or below.

If heat treatment is employed, the polymers are heated to the desired heat-treatment temperature and preferably maintained at such temperature for 1 minute or more and more preferably 5 minutes or more and most preferably 10 minutes or more. Below 1 minute no improvement in properties is generally seen. If the heating time is too long it becomes uneconomical and there is a risk that the polymer may be damaged. Preferably, polymer particles are maintained at the desired temperature for 60 minutes or less, preferably 40 minutes or less. Above 60 minutes no significant improvement in properties is generally noticed. The properties of the polymer particles can be adjusted and tailored by adjustment of the temperature and the time of the heating step.

After heat-treatment, the polymer particles may be difficult to handle due to static electricity. It may be desirable to rehumidify the particles to reduce or eliminate the effect of the static electricity. Methods of humidification of dry polymers are well known in the art. In a preferred mode, the dry particles are contacted with water vapor. The dry particles are contacted with a sufficient amount of water to reduce or eliminate the effects of the static electricity, yet not so much so as to cause the particles to agglomerate. Preferably, the dry particles are humidified with 0.3 percent or more by weight of water, and more preferably 2 percent or more by weight of water. Preferably, the dry particles are humidified with 10 percent or less by weight of water, and more preferably 6 percent or less by weight of water. Optionally, agglomeration prevention or rehydration additives maybe added to the crosslinked hydrophilic polymer. Such additives are well known in the art and include surfactants and inert inorganic particles such as silica; see, for example, U.S. Pat. Nos. 4,286,082; 4,734,478; and 4,179,367. Remoisturization can also be accomplished using certain salt solutions as taught in U.S. Pat. No. 6,323,252.

During and/or after the remoisturization step the dried and optionally heat-treated polymer particles may be contacted with a solution containing a dust control agent, for example a propoxylated polyol as described in U.S. Pat. Nos. 6,323,252 and 5,994,440. The propoxylated polyols are particularly suitable to bind the fine dust of the final superabsorbent polymer particles without causing agglomeration, and to bind the fine particles of powdery additives on the surface. The addition of the propoxylated polyol further results in a more homogeneous distribution of aqueous additives on the surface of the superabsorbent polymer particles in the absence of organic solvent. Exemplary propoxylated polyols are available from The Dow Chemical Company under the VORANOL brand. The propoxylated polyol is advantageously used in an amount of from 500 to 2,500 ppm, based on the weight of dry polymer. The concentration of the propoxylated polyol in water preferably ranges from 1 to 10 percent by weight and more preferably from 3 to 6 percent by weight.

During and/or after the remoisturization step, the dried hydrogel particles or the heat-treated superabsorbent polymer can optionally be mixed with additives. The additives added to the dried and/or heat-treated polymer particles prior to, during or after addition of the soluble iron salt can include, for example, activated carbon, chlorophyllin, chelating agents, soda, sodium bicarbonate, zinc sulfate, synthetic zeolites, natural zeolites, silicon dioxide, silicates, clay, cyclodextrin, citric acid, chitosan, ion exchange resin particles or combinations thereof. These additives may be employed as solids or as solutions or dispersions, depending on the additive.

The polymers according to the present invention have a low level of residual monomers due the treatment with iron ions. A considerable advantage of the present process is that the iron ions provide a beneficial decrease in residuals in both heat-treated and non-heat-treated polymers compared to polymers-obtained without the ionic iron treatment of the invention. Without wishing to be bound by the following theory, it is theorized that heating the polymers normally increases the amount of residual monomers due to thermally induced cleavage via a reverse Michael reaction. However, iron-treated polymers show a lower level of residuals compared with that observed when the polymer is heat-treated without the iron treatment.

The water-absorbent polymers of this invention can be used in any application wherein absorption and binding of aqueous fluids is desired. In a preferred embodiment, the water-absorbent polymer particles of this invention are mixed into or attached to a structure of absorbent material such as synthetic or natural fibers or paper based woven or non-woven fibers to form a structure. In such a structure the woven or non-woven structure functions as a mechanism for wicking and transporting via capillary action the fluid to the water-absorbent polymer particles which bind and retain such fluids. Examples of such structures are diapers, adult incontinence structures, and sanitary napkins. In addition, there are various applications of the superabsorbent polymers with low residual monomer in non-personal care applications, such as, for example, in medical care, agriculture, horticulture, gardening, fertilizer, pet litter, packaging and food packaging.

The absorbent structures according to the present invention comprise means to contain the water-absorbent polymer particles having a low level of residual monomers. Any means capable of containing the described water-absorbent polymer particles, which means is further capable of being positioned in a device such as an absorbent garment, is suitable for use in the present invention. Many such containment means are known to those skilled in the art. For example, the containment means may comprise a fibrous matrix such as an airlaid or wetlaid web of cellulosic fibers, a meltblown web of synthetic polymeric fibers, a spunbonded web of synthetic polymeric fibers, a coformed matrix comprising cellulosic fibers and fibers formed from a synthetic polymeric material, airlaid heat-fused webs of synthetic polymeric material, or open-celled foams. In one embodiment, it is preferred that the fibrous matrix comprise less than 10, preferably less than 5, percent by weight of cellulosic fibers.

The containment means may comprise a support structure, such as a polymeric film, on which the water-absorbent polymer particles is affixed. The water-absorbent polymer particles may be affixed to one or both sides of the support structure that may be water-pervious or water-impervious.

The absorbent structures according to the present invention are suitable for absorbing many fluids including body fluids, including, for example, urine, menses, and blood, and are suitable for use in absorbent garments such as diapers, adult incontinent products and bed pads; in catamenial devices such as sanitary napkins and tampons; and in other absorbent products such as, for example, wipes, bibs and wound dressings. Accordingly, in another aspect, the present invention relates to an absorbent device comprising an absorbent structure as described above.

The following examples are included to illustrate the invention, and do not limit the scope of the claims. Comparative Examples are marked with an asterisk. All parts and percentages are by weight unless otherwise indicated.

### EXAMPLES

Centrifuged Absorption Capacity

200 mg of water-absorbent polymer particles was placed within a sealable tea bag. (6.0 by 6.0 cm), immersed for 30 minutes into a 0.9 weight percent saline (sodium chloride) solution and then centrifuged for three minutes at 1300-1400 ppm. The weight ratio of saline solution absorbed to water-absorbent polymer particles was determined and reported as the centrifuged absorption capacity (CC).

Absorption Under Load

A nylon screen (50 by 50 mm; 100 mesh) was put on top of a perforated metal plate (holes with 5 mm) followed by a filter paper and finally by a stainless steel cylinder of 26 mm inner diameter, 37 mm outer diameter and a height of 50 mm, whose both ends were open. 167 mg of water-absorbent polymer particles was placed into the cylinder and evenly distributed, covered by a nonwoven sheet of a diameter of 26 mm and finally pressed down with a plastic piston of 26 mm diameter which carries the weight. The total weight of piston and cylinder is 109.4 g to give a 2.1 kPa (0.3 psi) load. Proportionately heavier pistons were used to apply loads of 4.1, 5.5, 6.2 and 6.9 kPa (0.6, 0.8, 0.9 and 1.0 psi). The metal plate with the product in the cylinder on top was immersed into the 0.9 percent saline solution such that the nylon screen and the water surface had the same level so that the filter paper and the water-absorbent polymer particles are able to absorb water without any hydrostatic pressure. A soak time of one hour was applied. The plate was removed from the water reservoir and the excess water in the holes of the plate and in the nylon screen was soaked up by paper tissues. Then the weight was removed from the swollen gel and the gel was weighed. The weight ratio of saline solution absorbed under load to water-absorbent polymer particles thus determined was reported as the absorption under load (AUL).

Extractables

1 g of water-absorbent polymer particles and 185 mL of 0.9 percent saline solution were placed in a 250 mL jar which was capped and put on a shaker for 16 hours. A part of the extraction solution was filtered. With the aid of a Metrohm Titroprocessor, the pH of a defined volume of the filtrate was adjusted to pH 10 by 0.1 N NaOH and finally titrated to pH 2.7 by 0.1 N hydrochloric acid, to determine the amount of extractable materials which was in the filtrate.

Residual Monomer

Residual acrylic acid was determined by adding 1 g of polymer, having a screened particle size between 30 and 50 mesh, to 185 g of a 0.9 wt. percent sodium chloride solution and shaking the mixture for 16 hours. The slurry obtained was passed through a Watman No. 3 filter paper. A sample of the filtrate was injected into a liquid chromatograph utilizing an ODS column and UV detection at 205 nm. The residual monomer was calculated by comparing the peak area of the acrylic acid peak to the peak of a standard sample. Concentrations are expressed in ppm, based on weight of dry polymer.

### Examples 1 to 4 and Comparative Example 5*:

Addition of Ferrous Ions to the Initial Monomer Mixture (Preparation Procedure 1)

A series of polymerization runs were performed with various concentrations of ferrous ions according to the following procedure.

281.5 g of a 20 wt. percent aqueous solution of sodium hydroxide and 62.65 g of de-ionized water were loaded into a glass flask which had a hollow jacket connected to a cooling water source. 104 g of acrylic acid were added slowly and the mixture was cooled to room temperature. 0.28 g of a 40 wt. percent active solution of VERSENEX 80, (Trademark of The Dow Chemical Company) (diethylene glycol triamine pentaacetate) and 0.395 g of a 10 wt. percent active sodium chlorate solution both were added to the pre-mixture.

1.19 g of HE-TMPTA (highly ethoxylated trimethylopropane triacrylate) were dissolved in 55.5 g of acrylic acid and the remaining acid together with the crosslinker was added into the flask. The resulting monomer mixture was placed in equal amounts in two 250 ml round bottom flasks, each equipped with a flange on the top.

The flange was sealed with a lid, which contained four openings of which two were reserved for a thermometer and a nitrogen gas supply. One opening was connected to the vent system and the fourth one was sealed with a septum. The contents of both flasks were stirred using magnetic stirrers.

In Examples 1 to 4 the appropriate amounts of a 0.1 wt. percent active solution of Fe (II) SO₄.7H₂O corresponding to 1 ppm Fe (0.40 g of solution), 3 ppm Fe (1.20 g of solution), 5 ppm Fe (1.98 g of solution) and 10 ppm Fe (3.97 g of solution), respectively, expressed in weight/weight ppm based on acrylic acid, were added to each of both flasks via the septum with a syringe. No Fe ions were added in Comparative Example 5. The mixtures were purged for 5 minutes with a rapid nitrogen stream to remove traces of oxygen. Nitrogen bubbling was reduced and 2.6 g of a 1 wt. percent active hydrogen peroxide solution, 1.27 g of a 10 wt. percent active aqueous sodium persulfate solution and 1.1 g of a 1 percent active aqueous ascorbic acid solution were introduced in sequence to the reaction mixture via the septum using syringes. In the absence of iron (Comparative Example 5), polymerization started about 5 minutes after the introduction of ascorbic acid at a temperature of approx. 22° C. In the presence of iron, initiation took place almost instantaneously after the addition of the initiators.

After the temperature of the flask contents peaked, the flasks were placed in a water bath for another 60 minutes at 70° C. Then, both flasks were opened and the aqueous polymer gel removed. The gel was minced in a common meat mincer and dried in a lab oven at 170° C. for two hours. The product was ground and screened between 100 and 800 micron for further analysis.

Heat Treatment Procedure:

Examples 1a, 2a, 3a, 4a and 5a* were not heat-treated, whereas Examples 1b, 2b, 3b, 4b and 5b* were subjected to heat treatment. Before the heat treatment step, a heating zone was pre-heated with a hot air gun. Once the targeted temperature was reached and stabilized, the sample (screened to contain only particles between 30 to 50 mesh) was placed in the zone and a contact thermometer was placed in contact with the sample. Hot air was blown through the dry particles thus fluidizing the whole mass. The temperature of the sample was monitored until it stabilized at 220° C. The sample was maintained at 220° C. for 20 minutes.

Table 1 describe the influences of varying amounts of ferrous ions on different properties, in particular the influence on residual monomer concentration.

TABLE 1

| | | | | | | Residual |
|---|---|---|---|---|---|---|
| | Iron Level | | AUL | AUL | Extract- | Monomer |
| | [ppm, b.o. | CC | (0.6 psi) | (0.9 psi) | ables | [ppm, b.o |
| Ex. | acrylic acid] | [g/g] | [g/g] | [g/g] | [percent] | dry polymer] |
| 1a | 1.0 | 32.2 | — | — | 8.4 | 662 |
| 1b | 1.0 | 31.6 | 25.3 | 19.5 | 9.2 | 453 |
| 2a | 3.0 | 33.5 | — | — | 10.1 | 490 |
| 2b | 3.0 | 32.7 | 25.1 | 18.7 | 11.1 | 304 |
| 3a | 5.0 | 34.0 | — | — | 10.2 | 423 |
| 3b | 5.0 | 33.4 | 24.8 | 15.9 | 11.5 | 244 |
| 4a | 10.0 | 33.6 | — | — | 10.0 | 381 |
| 4b | 10.0 | 32.0 | 23.8 | 14.9 | 11.2 | 260 |
| 5a* | 0.0 | 31.8 | — | — | 8.6 | 714 |
| 5b* | 0.0 | 30.4 | 24.9 | 20.2 | 9.1 | 570 |

### Examples 6 to 9 and Comparative Examples 10*:

Addition of Ferrous Ions to the Initial Monomer Mixture

The preparation procedure of the foregoing examples was repeated, except that the amount of HE-TMPTA was reduced to 0.26 g per flask and 0.60 g PEG 600 (polyethylene glycol with an average molecular weight of 600 g/mol) were added as latent crosslinker. In Example 6, 0.79 g of a 0.1 wt. percent active solution of Fe(II)SO₄.7H₂O corresponding to 2 ppm Fe were added to each of the flasks. Examples 6a, 7a, 8a, 9a and 10a* were not heat-treated, whereas Examples 6b, 7b, 8b, 9b and 10b* were subjected to a heat treatment as described above.

Table 2 describes the influences of varying amounts of ferrous ions on different properties, in particular the influence on residual monomer concentration.

TABLE 2

| | | | | | | Residual |
|---|---|---|---|---|---|---|
| | Iron Level | | AUL | AUL | Extract- | Monomer |
| | [ppm, b.o. | CC | (0.6 psi) | (0.9 psi) | ables | [ppm, b.o |
| Ex. | acrylic acid] | [g/g] | [g/g] | [g/g] | [percent] | dry polymer] |
| 6a | 2.0 | 37.5 | — | — | 12.0 | 331 |
| 6b | 2.0 | 32.3 | 25.5 | 19.8 | 7.5 | 266 |
| 7a | 3.0 | 39.7 | — | — | 13.5 | 318 |
| 7b | 3.0 | 34.5 | 25.8 | 20.2 | 8.2 | 244 |
| 8a | 5.0 | 40.4 | — | — | 15.1 | 244 |
| 8b | 5.0 | 36.1 | 23.5 | 16.6 | 10.3 | 166 |
| 9a | 10.0 | 39.8 | — | — | 14.6 | 200 |
| 9b | 10.0 | 34.6 | 23.8 | 17.9 | 10.6 | 143 |
| 10a* | 0.0 | 38.5 | — | — | 12.9 | 359 |
| 10b* | 0.0 | 30.8 | 24.4 | 20.0 | 7.3 | 306 |

### Examples 11, 12 and Comparative Examples 13*:

Addition of Iron Ions via the Initiator Solution

In Example 11, the preparation procedure of Example 1 was followed, except that the Fe(III) sulfate pentahydrate now was added together with the sodium persulfate solution (instead of adding Fe(II)SO₄.7H₂O to the mixture prior to initiator addition). The level of iron ions was 5 ppm, based on acrylic acid.

After the de-oxygenation step, 2.71 g of the aqueous sodium persulfate solution, 10 wt. percent active, containing 5.7 mg of iron (III) sulfate pentahydrate (Fe₂(SO₄)₃.5H₂O) were added with stirring to the monomer mixture.

In Example 12, the preparation procedure of Example 11 was followed, except that VERSENEX 80 was added to the persulfate solution in order to chelate the iron ions instantaneously. The level of the iron ions was 5 ppm, based on acrylic acid.

After the de-oxygenation step, 2.71 g of the aqueous sodium persulfate solution 10 wt. percent active, containing 5.7 mg of iron (III) sulfate (Fe₂(SO₄)₃) and 198 mg of the VERSENEX 80 solution (40:3 wt. percent active) were added to the mixture with stirring.

In Comparative Example 13*, 2.71 g of the aqueous sodium persulfate solution, 10 wt. percent active, together with 198 mg of the VERSENEX 80 solution (40.3. wt. percent active) were added to the mixture with stirring. Examples 11b, 12b and 13b* were heat-treated for 20 min. at 220° C. as described above. The properties of the resulting polymers are reported in Table 3.

TABLE 3

| | | | | | Residual |
|---|---|---|---|---|---|
| | | AUL | AUL | | Monomer |
| | | (0.6 psi) | (0.9 psi) | Extractables | [ppm, b.o dry |
| Example | CC [g/g] | [g/g] | [g/g] | [percent] | polymer] |
| 11a | 33.2 | — | — | 8.5 | 366 |
| 11b | 34.2 | 24.4 | 13.8 | 9.7 | 287 |
| 12a | 33.7 | — | — | 8.5 | 314 |
| 12b | 32.5 | 24.1 | 16.4 | 9.8 | 262 |
| 13a* | 32.7 | — | — | 7.4 | 587 |
| 13b* | 30.2 | 25.4 | 16.7 | 6.3 | 680 |

### Examples 14 to 17 and Comparative Examples 18*:

Addition of Ferrous Ions to the Wet Polymer Gel

Gel samples were prepared in a jacketed polymerization reactor equipped with a stainless steel agitator assembly and a high torque stirring motor with gear reducers. This assembly allowed grinding of the gel formed during polymerization. The reactor jacket was hollow and allowed heating or cooling of the reactor contents using water. The reactor was sealed and connected to a vacuum system, by which it was possible to cool the gel mass by pulling a vacuum. 37.2 kg acrylic acid was added slowly in a separate vessel to a mixture of 40.1 kg of an aqueous NaOH solution (50 wt. percent) and 77 kg process water in such a way as to prevent the temperature from going above 38° C. 70 g of a solution of triethylene diamine pentaacetate in water (VERSENEX 80) were added to the premix. 159 g of HE-TMPTA and 159 g PEG 600 were added to 15.9 kg of acrylic acid and the mixture obtained was poured into the premix after the premix was cooled to room temperature. The monomer mixture obtained was pumped into the reactor while purging the liquid with nitrogen. 124 g aqueous hydrogen peroxide (15 wt. percent active solution), 141 g of a sodium chlorate aqueous solution (10 wt. percent active) and 903 g of an aqueous sodium peroxodisulfate solution (10 wt. percent active) were added with a syringe to the reactor. Vacuum was pulled twice in order to remove oxygen and the reactor's headspace was filled with nitrogen again. The reaction was initiated by addition of 8 g of ascorbic acid dissolved in 80 g water. With beginning of the polymerization the external heater was set to 70° C. and a slow nitrogen flow was maintained though the reactor. The reactor contents were cooled to 70° C. after the polymerization medium reached its peak temperature by pulling a vacuum before the reactor was off-loaded.

500 g portions of the warm hydrogel were each mixed manually with 40 g of an aqueous solution of Fe₂(SO₄)₃.5H₂O. The concentration of the iron salt in the solution was adjusted to obtain the level of iron reported .in Table 4 with the aid of a stock solution.

The hydrogels were subsequently minced in a common household meat mincer and then dried in an oven at 170° C. for 2 hours. The oven-dried material was ground and sieved between 30 and 50 mesh for further characterization. Examples 14b, 15b, 16b, 17b and 18b* were heat-treated for 20 min. at 220° C. as described above. The properties of the resulting polymers are reported in Table 4.

TABLE 4

| | | | | | | Residual |
|---|---|---|---|---|---|---|
| | Iron Level | | AUL | AUL | Extract- | Monomer |
| | [ppm, b.o. | CC | (0.6 psi) | (0.9 psi) | ables | [ppm, b.o |
| Ex. | acrylic acid] | [g/g] | [g/g] | [g/g] | [percent] | dry polymer] |
| 14a | 2.0 | 35.8 | — | — | 10.8 | 374 |
| 14b | 2.0 | 31.4 | 26.1 | 22.1 | 6.9 | 326 |
| 15a | 6.0 | 36.1 | — | — | 11.2 | 347 |
| 15b | 6.0 | 33.3 | 26.2 | 21.6 | 9.2 | 247 |
| 16a | 10.0 | 35.9 | — | — | 10.7 | 362 |
| 16b | 10.0 | 34.6 | 27.1 | 21.7 | 9.1 | 259 |
| 17a | 14.0 | 34.4 | — | — | 10.0 | 330 |
| 17b | 14.0 | 34.4 | 25.8 | 19.3 | 11.9 | 222 |
| 18a* | 0.0 | 34.3 | — | — | 10.1 | 456 |
| 18b* | 0.0 | 28.6 | 25.2 | 22.3 | 5.0 | 438 |

The concentration of the iron salt in the aqueous solution may be varied over a wide range. Thus, the absolute quantity of water used during the experiments where an iron solution was added to the hydrogel was varied between 20 and 80 ml per 500 g of gel without seeing any particular effect on residual monomer (as long as the iron level was kept constant).

### Examples 19 and Comparative Examples 20*:

Addition of Ferric Ions to the Initial Monomer Mixture

In Example 19 the preparation procedure of Examples 1 to 4 was followed, except that iron(III) sulfate (Fe₂(SO₄)₃.5H₂O) was used instead of Fe(II)SO₄.7H₂O. The preparation procedure of Comparative Example 20* (no iron ions added) corresponds to that of Comparative Example 5*. Examples 19b and 20b* were heat-treated for 30 min. at 220° C. as described above. The properties of the resulting polymers are reported in Table 5.

TABLE 5

| | Iron level | | | Residual |
|---|---|---|---|---|
| | [ppm, b.o. | CC | Extractables | Monomer |
| Example | acrylic acid] | [g/g] | [percent] | [ppm, b.o dry polymer] |
| 19a | 5.0 | 32.2 | 8.3 | 444 |
| 19b | 5.0 | 32.9 | 9.8 | 449 |
| 20a* | 0.0 | 36.6 | 7.1 | 602 |
| 20b* | 0.0 | 30.5 | 7.2 | 711 |

It can be seen from all the examples that the presence of a few ppm iron ions reduces the concentration of the residual acrylic acid monomer in the resulting water-absorbent polymer. If the iron ions are added to the initial monomer mixture the ions may be applied anywhere during the preparation step; the iron salts, for example, can be added separately or together with the initiator solution. Alternatively, the iron ions may be added to the wet hydrogel after polymerization.

1. A process for the preparation of a water-absorbent polymer which comprises:
(I) polymerizing a polymerization mixture comprising:
(a) one or more ethylenically unsaturated carboxyl-containing monomers,
(b) one or more crosslinking agents,
(c) optionally one or more comonomers copolymerizable with the carboxyl-containing monomer,
(d) a polymerization medium, and
(e) a chlorine- or bromine-containing oxidation agent to form a crosslinked hydrogel;
(II) comminuting the hydrogel to particles; and
(III) drying the hydrogel at a temperature of greater than 105° C.;
wherein Fe(II) ions or Fe(III) ions or a mixture of both are added to the hydrogel prior to, during or after the comminution step (II) but prior to substantial drying of the hydrogel in step (III).

2. A process for the preparation of a water-absorbent polymer which comprises:
(I) polymerizing a polymerization mixture comprising:
(a) one or more ethylenically unsaturated carboxyl-containing monomers,
(b) one or more crosslinking agents,
(c) optionally one or more comonomers copolymerizable with the carboxyl-containing monomer,
(d) a polymerization medium, and
(e) a chlorine- or bromine-containing oxidation agent to form a crosslinked hydrogel;
(II) comminuting the hydrogel to particles; and
(III) drying the hydrogel at a temperature of greater than 105° C.; wherein Fe(II) ions or Fe(III) ions or a mixture of both are added in an amount of from 1 to 20 ppm, based on the total weight of monomers, to the polymerization mixture prior to step (I).

3. A process for the preparation of a water-absorbent polymer which comprises:
(I) polymerizing a polymerization mixture comprising:
(a) one or more ethylenically unsaturated carboxyl-containing monomers,
(b) one or more crosslinking agents
(c) optionally one or more comonomers copolymerizable with the carboxyl-containing monomer,
(d) a polymerization medium, and
(e) a chlorine- or bromine-containing oxidation agent to form a crosslinked hydrogel;
(II) comminuting the hydrogel to particles; and
(III) drying the hydrogel at a temperature of greater than 105° C.; wherein Fe(III) ions are added to the polymerization mixture prior to step (I).

4. A process for the preparation of a water-absorbent polymer which comprises:
(I) polymerizing a polymerization mixture comprising:
(a) one or more ethylenically unsaturated carboxyl-containing monomers,
(b) one or more crosslinking agents,
(c) optionally one or more comonomers copolymerizable with the carboxyl-containing monomer, and
(d) a polymerization medium to form a crosslinked hydrogel;
(II) comminuting the hydrogel to particles;
(III) applying to the hydrogel a chlorine- or bromine-containing oxidation agent prior to, during or after the comminution step (II); and
(IV) drying the hydrogel at a temperature of greater than 105° C.;
wherein Fe(II) ions or Fe(III) ions or a mixture of both are added in at least one of the following steps:
(i) prior to the comminution step (II) or
(ii) after the comminution step (II) but prior to substantial drying of the hydrogel in step (IV).

5. A process for the preparation of a water-absorbent polymer which comprises:
(I) polymerizing a polymerization mixture comprising:
(a) one or more ethylenically unsaturated carboxyl-containing monomers,
(b) one or more crosslinking agents,
(c) optionally one or more comonomers copolymerizable with the carboxyl-containing monomer, and
(d) a polymerization medium to form a crosslinked hydrogel;
(II) comminuting the hydrogel to particles;
(III) applying to the hydrogel a chlorine- or bromine-containing oxidation agent prior to, during or after the comminution step (II); and
(IV) drying the hydrogel at a temperature of greater than 105° C.; wherein Fe(II) ions or Fe(III) ions or a mixture of both are added in an amount of from 1 to 20 ppm, based on the total weight of monomers, to the polymerization mixture prior to or during step (I).

6. A process for the preparation of a water-absorbent polymer which comprises:
(I) polymerizing a polymerization mixture comprising:
(a) one or more ethylenically unsaturated carboxyl-containing monomers,
(b) one or more crosslinking agents,
(c) optionally one or more comonomers copolymerizable with the carboxyl-containing monomer, and
(d) a polymerization medium to form a crosslinked hydrogel;
(II) comminuting the hydrogel to particles;
(III) applying to the hydrogel a chlorine- or bromine-containing oxidation agent prior to, during or after the comminution step (II); and
(IV) drying the hydrogel at a temperature of greater than 105C; wherein Fe(III) ions are added to the polymerization mixture prior to step (I).

7. The process of claim 1 further comprising (IV) grinding, screening and heat treating the dried hydrogel after step (III).

8. (canceled)

9. (canceled)

10. (canceled)

11. (canceled)

12. (canceled)

13. The process of claim 1 wherein the Fe(II) ions or Fe(III) ions or a mixture of both are added in a total amount of from 1 to 20 ppm, based on the total weight of monomers.

14. The process of claim 3 wherein the Fe(III) ions are added in an amount of from 1 to 20 ppm, based on the total weight of monomers.

15. (canceled)

16. (canceled)

17. The process of claim 1 wherein the Fe(II) ions are derived from iron (II) acetate, iron (II) chloride, iron (II) sulfate, iron (II) acetate, iron (II) bromide, iron (II) citrate, iron (II) lactate or iron (II) nitrate or mixtures thereof.

18. The process of claim 1 further comprises a surface crosslinking step (IV).

19. The process of claim 1 wherein the Fe(III) ions are derived from iron (III) chloride, iron (III) sulfate, iron (III) bromide, iron (III) citrate, iron (III) lactate, iron (III) nitrate or iron (III) oxalate or mixtures thereof

20. (canceled)

21. The process of claim 1 wherein the chlorine- or bromine-containing oxidizing agent is selected from the group consisting of sodium chlorate, potassium chlorate, sodium bromate, potassium bromate, sodium chlorite and potassium chlorite or mixtures thereof.

22. (canceled)

23. (canceled)

24. (canceled)

25. (canceled)

26. (canceled)

27. A process for the preparation of a water-absorbent polymer, the process comprising
(I) polymerizing a polymerization mixture comprising:
(a) one or more ethylenically unsaturated carboxyl-containing monomers.
(b) one or more crosslinking agents,
(c) optionally one or more comonomers copolymerizable with the carboxyl-containing monomer, and
(d) a polymerization medium, and to form a crosslinked hydrogel,
(II) comminuting the hydrogel to particles; and
(III) drying the hydrogel at a temperature of greater than 105C;
wherein, under conditions sufficient to reduce the residual monomer level in the polymer product, the following are independently added to the process prior to substantial drying of the hydrogel in step (III): (a) Fe(III) ions; and (b) at least one chlorine- or bromine-containing oxidation agent.
